(19) United States
(12) Patent Application Publication
(10) Pub. No.: US 2022/0234494 A1
(43) Pub. Date: Jul. 28, 2022

(54) LED LIGHT STICK FOR A VEHICLE

(71) Applicant: Joseph WU, Glendora, CA (US)

(72) Inventor: Joseph WU, Glendora, CA (US)

(21) Appl. No.: 17/506,150

(22) Filed: Oct. 20, 2021

Related U.S. Application Data
(60) Provisional application No. 63/140,528, filed on Jan. 22, 2021.

(51) Int. Cl. B60Q 1/24; F21V 23/06; F21V 23/04; F21V 21/14

(52) U.S. Cl. CPC B60Q 1/24; F21V 23/06; F21Y 2115/10; F21V 21/14; F21V 23/0435

(57) ABSTRACT

An apparatus connecting to a hitch of a vehicle. The apparatus includes a light emitting diode (LED) light stick mounted to the hitch of the vehicle via a hitch adapter. The hitch adapter configurably slides into a hitch mount of the vehicle.

### CROSS-REFERENCE TO A RELATED APPLICATION

This application claims the benefit of U.S. provisional patent application Ser. No. 63/140,528, filed on Jan. 22, 2021. The subject matter of the earlier filed application is incorporated herein by reference in it its entirety.

### FIELD

The present invention relates to a light emitting diode (LED) light stick, and more particularly, to a LED light stick that mounts to a hitch of a vehicle.

### BACKGROUND

There are numerous vehicles, such as pickup trucks, that place a flagpole on the rear by connecting the flagpole to the hitch of the vehicle. However, during the evening or at night, these flagpoles are not clearly visible by other drivers. Further, for nighttime and daytime driving in a pickup truck, at a distance, the driving lights may not be bright enough or tall enough for others to see and identify.

Thus, an alternative flagpole may be beneficial to overcome the deficiencies in the current state of the art.

### SUMMARY

Certain embodiments of the present invention may provide solutions to the problems and needs in the art that have not yet been fully identified, appreciated, or solved by current sticks that mount to a vehicle. For example, some embodiments of the present invention pertain to a LED light stick that can mount directly to the hitch of the vehicle and power off the trailer harness for ease of use. Currently, there are no off-the-shelf components for LED light sticks that mount into a trailer hitch and derive its power from a trailer hitch receiver power plug.

In one embodiment, an apparatus connecting to a hitch of a vehicle includes a light emitting diode (LED) light stick mounted to the hitch of the vehicle via a hitch adapter. The hitch adapter configurably slides into a hitch mount of the vehicle.

In another embodiment, apparatus configured to connect to a hitch of a vehicle includes LED light stick mounted to the hitch of the vehicle via a hitch adapter. The adapter configurably slides into a hitch mount of the vehicle, and includes an angling mechanism is configured to change a positioning of the LED light stick, the change of positioning is 180 degrees.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1A and 1B are diagrams illustrating a light emitting diode (LED) stick assembly, according to an embodiment of the present invention.

FIGS. 2A-D are diagrams illustrating various hitch adapters, according to an embodiment of the present invention.

FIG. 3 is a diagram illustrating an angling mechanism allowing a house to be adjusted, according to an embodiment of the present invention.

FIG. 4 is a diagram illustrating a plurality of LED light sticks attached to the hitch of a vehicle, according to an embodiment of the present invention.

### DETAILED DESCRIPTION OF THE EMBODIMENTS

Some embodiments pertain to an apparatus connecting to a hitch of a vehicle includes a light emitting diode (LED) light stick mounted to the hitch of the vehicle via a hitch adapter.

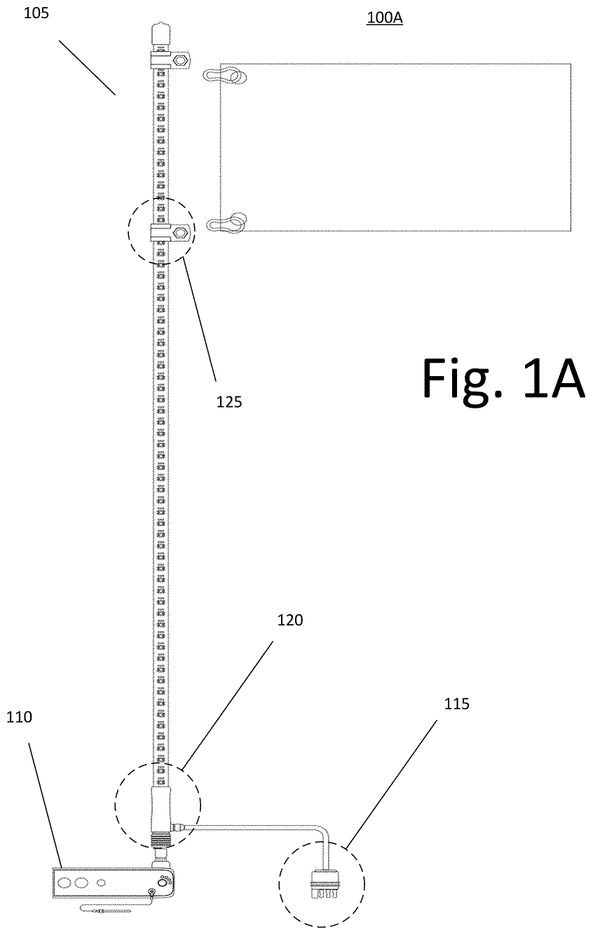

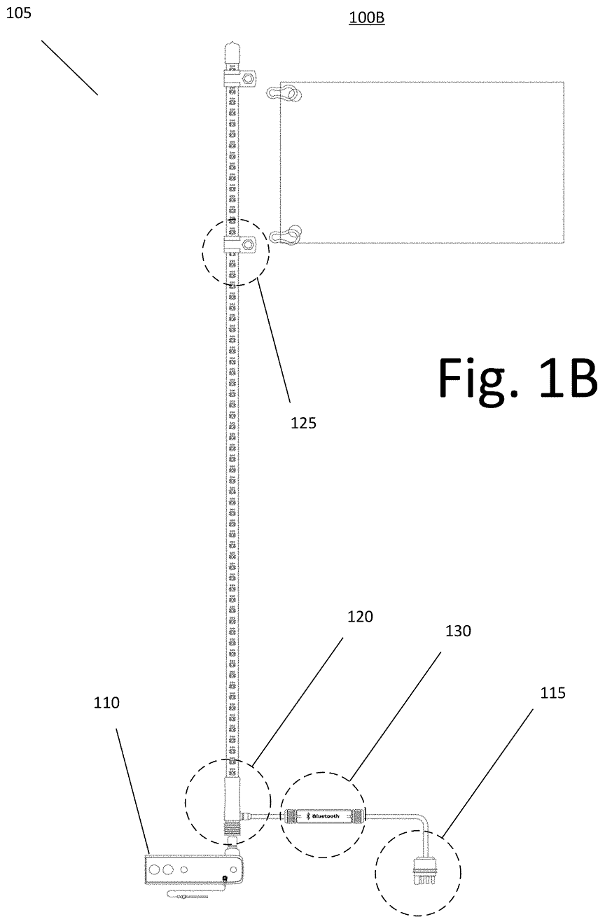

FIGS. 1A and 1B are diagrams illustrating a LED stick assembly (flagpole) 100 configured to connect to a hitch of a vehicle, according to an embodiment of the present invention. In some embodiments, LED light stick 105 is mounted to the hitch of the vehicle (not shown) via a hitch adapter 110. Hitch adapter 110 may slide into a hitch mount of the vehicle. As is common with typical hitch systems, hitch adapter 110 includes a lock and key system to prevent LED light stick 105 from sliding out of the hitch of the vehicle. In an alternative embodiment, hitch adapter 110 may include an electrical or magnetic connection securely connecting with the hitch of the vehicle. Hitch adapter 110 may be composed of aluminum providing a lightweight and durable adapter. In an alternative embodiment, hitch adapter 110 is composed of metal for increased durability.

LED stick assembly 100 may also include a power plug 115 extending out of from LED light stick 105 that plugs into a power port of the vehicle (also not shown). Power plug 115 is configured to be synced with one or more lights on the vehicle. For example, depending on the pin configuration of power plug 115, LED light stick 105 may illuminate. For example, in a four pin power plug configuration, when a brake light or right turn signal is illuminated on the vehicle, LED light stick 105 may also illuminate in a solid manner or blinking manner. In another example, in a five or seven pin configuration, when one or more other lights on the vehicle are illuminated, LED light stick 105 may also illuminate.

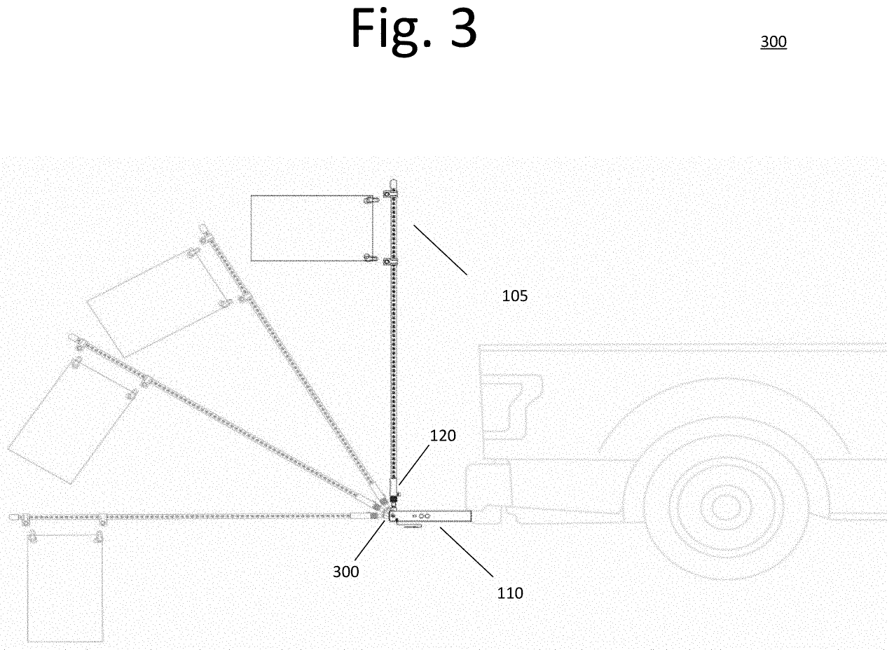

A house 120 may house the base of LED light stick 105 and also provide stability with respect to LED light stick 105. The base of LED light stick 105 may hold an integrated circuit (IC) board, which controls features, such as colors, patterns, etc., of LED light stick 105. This base may be secured within house 120. House 120 may be angled, allowing LED light stick 105 to be adjusted to any varying degree, i.e., upright or slanted degree. See FIG. 3, which is a diagram illustrating an angling mechanism 300 allowing a house 120 to be adjusted, according to an embodiment of the present invention. In some embodiments, angling mechanism 300 may be part of hitch adapter 110 and may be able to move about a 180 degree axis.

LED light stick 105 may also include a pair of adapters 125, allowing a flag to be connected to LED light stick 105. Adapters 125 may allow flag to be clipped onto LED light stick, or in some embodiments, may include wired connections allowing the flag to illuminate, provided that the flag is configured to illuminate.

In certain embodiments, LED light stick 105 may be operable with a wireless device such as Bluetooth or BLE™ technology. See FIG. 1B. For example, power plug 115 may include a Bluetooth device 130, which may be integrated on the power line.

In some embodiments, power plug 115, once connected to the power port of the vehicle, causes Bluetooth device 130 to power on. Right after, a user may connect his or her mobile device or tablet (neither shown) to Bluetooth device 130. In one example, the mobile device may include a mobile (or software) application configured to connect to Bluetooth device, and cause the Bluetooth device to send signals to LED light stick 105 which houses the LEDs. The signals may cause LEDs to illuminate. The mobile application, although not shown, may cause LED light stick to illuminate in different colors, patterns, and also pulse the LEDs according to the beats of the music.

The Bluetooth device may also pair with a vehicles Bluetooth transmitter to communicate turn signal, hazard, or brake lights.

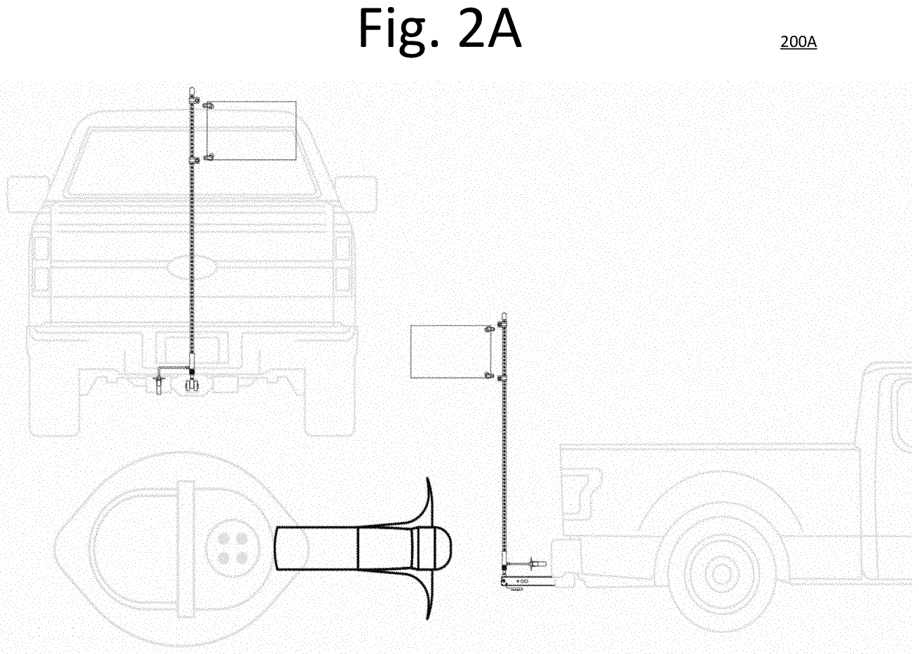

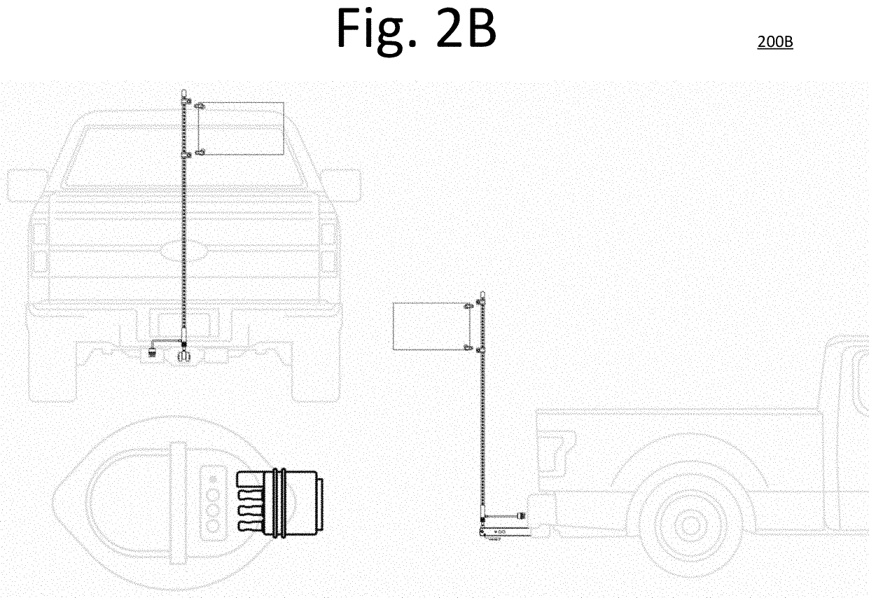

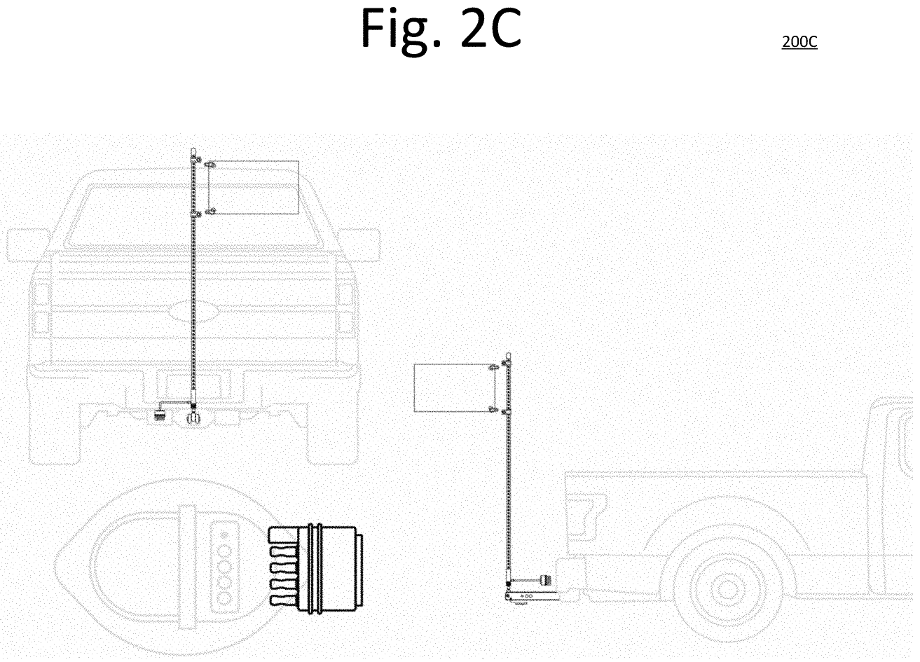

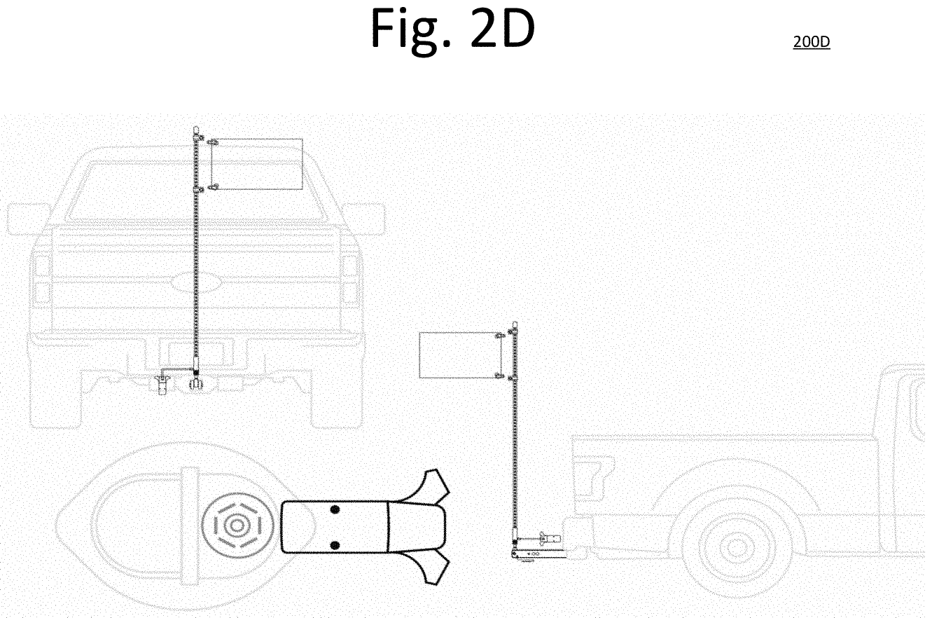

FIGS. 2A-D are diagrams illustrating various hitch adapters 200A-D, according to an embodiment of the present invention. For example, hitch adapters 200A-D may range from a 4 pin flat hitch adapter, a 4 pin round high adapter, a 5 pin flat high adapter, and a 7 pin high adapter. In certain embodiments, a base that attaches to hitch adapter 200A-D may pivot changing the angle of LED light stick.

Depending on the pin configuration of hitch adapter 200A-D, various functionalities may be afforded to the LED light stick. For example, the LED light stick may illuminate when the brake pedal is pressed, left turn or right turn are activated, and nighttime driving lights are turned, to name a few. Also, depending on the pin configuration, the LED light stick may illuminate when daytime lights are turned on or when the brake pedal is pressed. In another example, the LED light stick may also blink when the left or right turn signal is turned on. During nighttime, the LED light stick is always on, but can be configured to blink with turn signal is activated or when the brake pedal is pressed.

In some embodiments, a wireless remote may allow users to change colors and LED light patterns on the LED light stick. When there are multiple vehicles with LED light sticks, each vehicle may have a different color or pattern for identification.

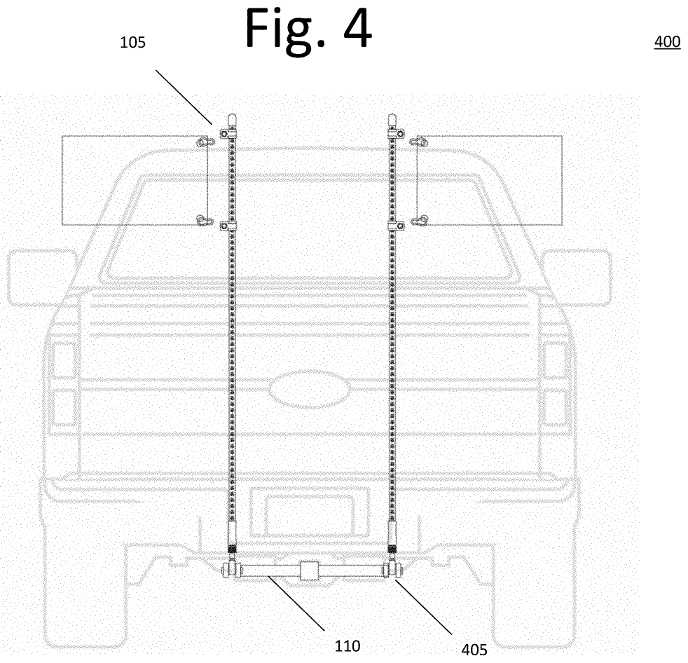

In some further embodiments, a plurality of LED light sticks may connect to the hitch of the vehicle. FIG. 4 is a diagram illustrating a plurality of LED light sticks 100 attached to the hitch of a vehicle, according to an embodiment of the present invention. In order for each LED light stick 105 to mount to the vehicle, a hitch adapter 110 may include a plurality of housings 405 that facilitate attachment to the LED light sticks. This way, hitch adapter 110, when mounted to the hitch of the vehicle, allows for a plurality of LED light sticks 105 to be attached to a single hitch on the vehicle.

It should be appreciated that although a LED light stick is described herein, other embodiments may include a Christmas tree or any other object that would be appreciated by a person of ordinary skill in the art.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus configured to connect to a hitch of a vehicle, comprising:
a light emitting diode (LED) light stick mounted to the hitch of the vehicle via a hitch adapter, wherein
the hitch adapter configurably slides into a hitch mount of the vehicle, and
the hitch adapter further comprising an angling mechanism configured to change a positioning of the LED light stick, wherein
the change of positioning is 90 degrees, causing the LED light stick to move from a vertical position to a horizontal position and visa versa.

2. The apparatus of claim 1, wherein the hitch mount is composed of aluminum piece providing durability.

3. The apparatus of claim 1, further comprising:
a power plug extending out of from the LED light stick is configured to plug into a power port of the vehicle.

4. The apparatus of claim 3, wherein the power plug is configured to be synced with one or more lights on the vehicle.

5. The apparatus of claim 3, further comprising:
a wireless communication device attached to a power line connecting the power plug to the LED light stick, wherein
the wireless communication device is configured to cause the LED light stick to illuminate when a signal is received from a wireless device, and
the wireless device executing an application configured to cause the LED light stick to illuminate.

6. The apparatus of claim 3, wherein the power plug comprises a four pin plug, a five pin plug, or a seven pin plug.

7. The apparatus of claim 6, wherein, depending on pin configuration of the power plug, the LED light stick is configured to illuminate.

8. (canceled)

9. The apparatus of claim 1, further comprising:
a house configured to hold a base of the LED light stick and also provide stability with respect to the LED light stick.

10. The apparatus of claim 9, wherein the base of the LED light stick comprises an integrated circuit (IC) board controlling illuminating features of the LED light stick.

11. An apparatus configured to connect to a hitch of a vehicle, comprising:
a light emitting diode (LED) light stick mounted to the hitch of the vehicle via a hitch adapter, wherein
the hitch adapter configurably slides into a hitch mount of the vehicle,
the hitch adapter comprising an angling mechanism is configured to change a positioning of the LED light stick, the change of positioning is 180 degrees.

12. The apparatus of claim 11, wherein the hitch mount is composed of aluminum piece providing durability.

13. The apparatus of claim 11, further comprising:
a power plug extending out of from the LED light stick is configured to plug into a power port of the vehicle.

14. The apparatus of claim 13, wherein the power plug is configured to be synced with one or more lights on the vehicle.

15. The apparatus of claim 13, wherein the power plug comprises a four pin plug, a five pin plug, or a seven pin plug.

16. The apparatus of claim 15, wherein, depending on pin configuration of the power plug, the LED light stick is configured to illuminate.

17. The apparatus of claim 11, wherein the hitch adapter further comprising an angling mechanism configured to change a positioning of the LED light stick, and
the change of positioning is 180 degrees.

18. The apparatus of claim 11, further comprising:
a house configured to hold a base of the LED light stick and also provide stability with respect to the LED light stick.

19. The apparatus of claim 18, wherein the base of the LED light stick comprises an integrated circuit (IC) board controlling illuminating features of the LED light stick.
